(19) United States
(12) Patent Application Publication
(10) Pub. No.: US 2008/0157660 A1
(43) Pub. Date: Jul. 3, 2008

(54) SUBSTRATE FOR ORGANIC EL DISPLAY AND METHOD OF PRODUCING THE SUBSTRATE

(75) Inventors: Junji Ohyama, Yokohama-shi (JP); Tomonari Horikiri, Sagamihara-shi (JP); Katsumi Nakagawa, Yokohama-shi (JP); Hiroyuki Fuchigami, Kobe-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/964,396

(22) Filed: Dec. 26, 2007

(30) Foreign Application Priority Data
Dec. 28, 2006 (JP) 2006-354679

(51) Int. Cl. H01J 63/04

(52) U.S. Cl. 313/504; 445/13

(57) ABSTRACT

A substrate for an organic EL display including an insulating layer, in which release of a substance derived from a material for the insulating layer by heating at a temperature equal to or lower than a temperature obtained by subtracting 20° C. from a decomposition temperature of the material for the insulating layer is detected by mass spectrometric detection at an S/N ratio smaller than 3/1.

### BACKGROUND OF THE INVENTION

1. Field of the Invention

The present invention relates to a substrate for a display apparatus, in particular, a substrate for a display apparatus suitable for, for example, an active matrix type organic electroluminescence display using an organic light-emitting device such as an organic electroluminescence device as a display device, and a method of producing the substrate.

2. Description of the Related Art

An organic electroluminescence (hereinafter referred to as “EL”) device utilizing the electroluminescence of an organic material is obtained by providing, between an anode and a cathode, organic layers obtained by stacking an organic carrier transport layer and an organic light-emitting layer. The organic EL device has been attracting attention because of its potential to serve as a light-emitting device capable of being driven at a low DC voltage and of emitting light with high luminance.

Of the display apparatuses each using an organic EL device, an active matrix type display apparatus obtained by providing each pixel with a thin film transistor (hereinafter referred to as “TFT”) for driving a device has been particularly vigorously developed for the purpose of achieving its high image quality and long lifetime.

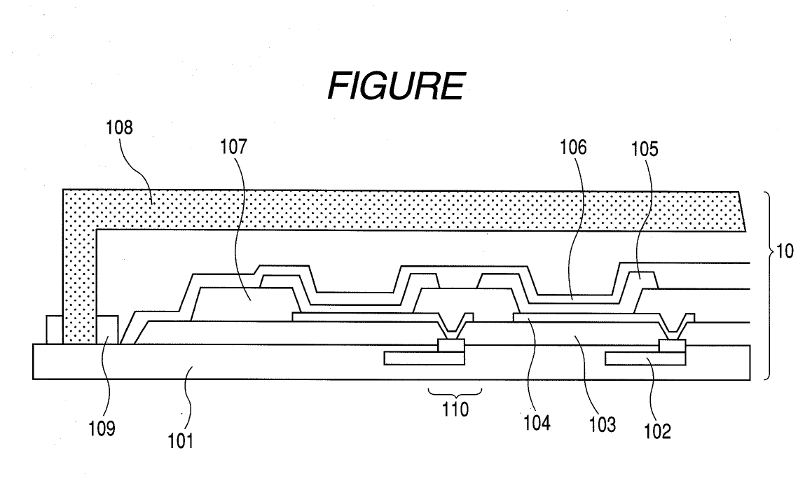

FIG. 1 shows the outline view of an active matrix type organic EL display apparatus. First, reference numerals in the FIGURE will be described.

Reference numeral 10 represents an organic EL display light-emitting portion; 101, a base material; 102, a thin film transistor (TFT); 103, a first insulating layer (planarizing film); 104, a lower electrode (pixel electrode); 105, an organic EL layer; 106, an upper counter electrode; 107, a second insulating layer (device isolation film); 108, a glass sealing member; 109, an adhesive; and 110, a contact hole.

The second insulating layer (device isolation film) 107 is formed into a desired bank shape through application such as a spin coating method, patterning, and heat curing. As shown in FIG. 1, the second insulating layer 107 is formed on part of the surface of each of the first insulating layer (planarizing film) 103 and the lower electrode 104 formed in advance. Therefore, each of the first insulating layer 103 and the lower electrode 104 is required to have, for example, resistance against the application of a material for the second insulating layer 107 (that is, solvent resistance) and resistance against heat curing (that is, heat resistance) needed in the step of forming the second insulating layer 107.

In particular, when the first insulating layer 103 contains an organic compound such as an acrylic acid-based resin, a novolac-based resin, or a polyimide-based resin, the layer cannot show solvent resistance or heat resistance needed in the formation of the second insulating layer 107, with the result that the physical and chemical properties of the first insulating layer 103 may change and alter.

To solve the foregoing problem, Japanese Patent Application Laid-Open No. 2004-111361 discloses that a second organic insulating substance (device isolation film) is desirably selected from organic insulating substances each having a film formation temperature lower than that of a first organic insulating substance (planarizing film).

On the other hand, the production of an organic EL display passes an exposure patterning step for the formation of the first and second insulating layers and the formation of the lower electrode. For exposure pattern development, a substrate is exposed to water for a long time period; for example, the substrate is immersed in a developing solution diluting solution, or is washed with a large amount of pure water for rinsing. When the first and second insulating layers are each formed of an organic compound, there is a high possibility that each of the layers absorbs a large amount of water during the step.

It is a known fact that, when a component of the organic EL display contains water, organic EL emission intensity may reduce at an early stage, a perfect non-light-emitting region may be formed in a pixel, or the light-emitting characteristic of the display may degrade and reduce.

To solve the foregoing problem, Japanese Patent No. 3531597 discloses that, prior to the formation of a light-emitting layer of the organic EL display, each insulating layer should be dehydrated by heating the substrate to 80° C. or higher so that an actual light-emitting region may account for 80% of the area of the entire region capable of emitting light.

In actuality, however, for example, baking for the formation of the second insulating layer is desirably performed at high temperatures because a good film can be obtained. Accordingly, even when a material for the second insulating layer is selected from insulating materials each having a film formation temperature lower than that of a material for the first insulating layer as described in Japanese Patent Application Laid-Open No. 2004-111361, thermal damage (such as decomposition or a change in color) to the first insulating layer occurs depending on a method of post-baking the second insulating layer. Therefore, a relationship between the heat resistance of the second organic insulating substance and the heat resistance of the first organic insulating substance must be established on the basis of a requirement different from that disclosed in Japanese Patent Application Laid-Open No. 2004-111361.

In addition, in order that an organic EL display having a certain light-emitting characteristic may be obtained, as described in Japanese Patent No. 3531597, the step of dehydrating the entirety of the substrate by heating is needed immediately after the completion of a substrate patterning step, that is, prior to the formation of an organic light-emitting layer. Naturally, it is easily demonstrated that both a dehydration amount and a dehydration rate increase as the temperature at which the dehydrating step is performed increases. However, when a heating temperature in the dehydrating step exceeds the heatproof temperature of a component of the organic EL display, the component may be thermally damaged. As a result, each of the first insulating layer and the second insulating layer fails to exert a desired function, and this leads to the emergence of problems such as a reduction in emission luminance of the organic EL display and the shortening of the lifetime of the display.

That is, measures for the elimination and control of influences from the heating step, the measures being described in none of Japanese Patent Application Laid-Open No. 2004-111361 and Japanese Patent No. 3531597, are needed.

### SUMMARY OF THE INVENTION

In view of the foregoing, an object of the present invention is to provide a method of producing a substrate for an organic EL display which does not degrade the characteristics of an insulating layer as well as a substrate for an organic EL display which can achieve a display stably driven for a long term period and with higher performance.

A substrate for an organic EL display of the present invention includes an insulating layer, in which release of a substance derived from a material for the insulating layer by heating at a temperature equal to or lower than a temperature obtained by subtracting 20° C. from a decomposition temperature of the material for the insulating layer is detected by mass spectrometric detection at an S/N ratio smaller than 3/1.

Further, a substrate for an organic EL display of the present invention includes: a planarizing film formed of an organic compound; and a device isolation film formed of an organic compound,

in which: a decomposition temperature of a material for the planarizing film is higher than a decomposition temperature of a material for the device isolation film; and release of a substance derived from the material for the planarizing film by heating at a temperature equal to or lower than a temperature obtained by subtracting 20° C. from the decomposition temperature of the material for the planarizing film is detected by a mass spectrometric detection method at an S/N ratio smaller than 3/1.

A method of producing a substrate for an organic EL display of the present invention having an insulating layer, the method including the step of forming the insulating layer, in which the step of forming the insulating layer includes:

a step of applying a solution of a material for the insulating layer having a photosensitive acid-generating portion or a precursor material for the material dissolved or dispersed in a solvent to thereby form a film;

a first heating step of heating the film and removing the solvent in the film;

a step of patterning the film by irradiating the first-heated film with light through a mask;

a second heating step of heating the patterned film under an atmosphere for maintaining a temperature equal to or higher than a heat decomposition temperature of the photosensitive acid-generating portion and lower than a curing temperature or a polymerization temperature of the material for the insulating layer; and

a third heating step of heating the second-heated film under an atmosphere for increasing a temperature of the film up to a temperature equal to or lower than a temperature obtained by subtracting 20° C. from a decomposition temperature of the material for the insulating layer at a rate of temperature increase of 10° C./min or less and maintaining the temperature for 30 minutes or longer.

The use of the substrate for an organic EL display of the present invention can provide a display which can more stably be driven for a longer time period and can achieve higher performance.

Further features of the present invention will become apparent from the following description of exemplary embodiments with reference to the attached drawing.

### BRIEF DESCRIPTION OF THE DRAWINGS

FIGURE is a schematic sectional view showing a pixel portion of an active matrix type organic EL display using a substrate of the present invention.

### DESCRIPTION OF THE EMBODIMENTS

Next, the present invention will be described in detail. However, materials used in the present invention to be described later are not particularly limited to the following examples.

FIGURE shows an outline view of an active matrix type organic EL display apparatus using a substrate of the present invention. As shown in the FIGURE, an organic EL display light-emitting portion 10 is placed in a matrix fashion on a base material 101, and a TFT 102 for driving an EL device is built in each pixel. Driver circuits (not shown) for driving each pixel are also built in the periphery of the TFT. Such circuits are formed of the TFT 102 and wiring, and are connected to an external circuit through a group of external lead-out terminals (not shown) for driving. In addition, above the organic EL display light-emitting portion 10 and the driver circuit, a glass sealing member 108 is bonded to the base material 101 with an adhesive 109 for the purposes of maintaining the mechanical strength of the apparatus and of preventing the permeation of water over the entire display region of the apparatus.

In the substrate shown in FIGURE, a first insulating layer (planarizing film) 103 is provided for the purposes of insulating and planarizing the surface of the TFT 102 and the wiring provided on the base material 101 by covering the TFT and the wiring. Further, a lower electrode (pixel electrode) 104 formed of a metal or a transparent conductive film layer is formed on the first insulating layer 103. In addition, a second insulating layer (device isolation film) 107 is formed so that organic EL layer materials may be prevented from mixing between adjacent display pixels upon formation of organic EL layers 105.

The organic EL layers 105 including an organic light-emitting layer formed of at least one kind of a compound are formed on the substrate of the present invention by a method such as vapor deposition, sputtering, or application. In this case, a hole transport/injection layer or an electron transport/injection layer may be formed above and below the organic light-emitting layer to sandwich the organic light-emitting layer. Further, subsequently, a metal or a transparent conductive film layer is formed as an upper counter electrode 106, whereby an organic EL display is obtained. It should be noted that an organic EL device including the lower electrode 104 and the driver circuit are connected to each other through a contact hole 110 patterned and formed in the first insulating layer 103.

Materials to be used in the first insulating layer 103 and the second insulating layer 107 are as follows: both the materials have such insulating property that the materials show a volume resistivity of 1×10¹⁵ Ω·cm or more after being formed into a film and cured, and both the materials can be patterned by a certain method before being cured. For example, a (meth)acrylic resin, a novolac resin, a polyamide resin, or a polyimide resin can be used. Materials of the same kind, preferably materials having different heat decomposition temperatures are selected for use from those materials.

In the substrate shown in FIG. 1, the decomposition temperature of a material for the first insulating layer (planarizing film) 103 is higher than that of a material for the second insulating layer (device isolation film) 107. In addition, the release of a substance derived from the material for the first insulating layer (planarizing film) 103 by heating at a temperature equal to or lower than a temperature obtained by subtracting 20° C. from the decomposition temperature of the material for the first insulating layer (planarizing film) 103 is detected by a mass spectrometric detection method at an S/N ratio smaller than 3/1.

When the release is detected at an S/N ratio of 3/1 or more, at least the insulating layer as an object to be measured is considered to undergo heat decomposition. It should be noted that, in mass spectrometry, at an m/z of about 40 or less, the desorption of: a residual component such as a solvent or a developing solution to be used at the time of the formation of the insulating layer; or water is detected to a large extent. Therefore, a mass substance having an m/z in excess of 50 and represented by a certain chemical formula is defined as a “substance derived from the material for the insulating layer (planarizing film)”.

In mass spectrometry, a thermal desorption spectrometer (TDS) that measures the desorption of a substance from an object to be measured with a quadrupole mass spectrometer while heating the object under a vacuum of about 1×10⁻¹. Pa or more or under an inert gas atmosphere at normal pressure is preferably used.

In general, upon formation of an insulating layer, a proper temperature margin from the decomposition temperature of a material for the insulating layer is as follows: a curing/polymerization temperature is set to be equal to or lower than a temperature obtained by subtracting 10° C. from the decomposition temperature. Further, it is sufficient that no decomposed product of the material for the insulating layer is detected in a proper temperature margin from the curing/polymerization temperature, that is, at a temperature equal to or lower than a temperature obtained by subtracting 10° C. from the curing/polymerization temperature. Accordingly, in the present invention, the upper limit for the temperature at which mass spectrometry is performed is set to a temperature obtained by subtracting 20° C. from the decomposition temperature.

Next, a method of producing a substrate for an organic EL display of the present invention will be described.

In the production method of the present invention, in order that an insulating layer may be formed, first, a solution prepared by dissolving or dispersing a material for the insulating layer having a photosensitive acid-generating portion or a precursor material for the material in a solvent is applied in a certain thickness by a spin coating method or the like. Then, the coating film is preliminarily heated at a certain temperature so that the solvent in the film is appropriately evaporated (first heating step). After that, the resultant film is patterned by being irradiated with light such as ultraviolet light through a mask.

Patterning methods include a method involving stacking an additional photoresist on the insulating layer, irradiating the photoresist with ultraviolet light through a mask to form an opening portion and etching the opening portion together with the insulating layer by wet etching or dry etching; and a method involving the use of a material for the insulating layer in which a compound that is sensitized to light to generate an acid is carried on the material in advance, that is, the use of a resist material.

In the present invention, the latter method can be preferably used. That is, when the photosensitive acid-generating portion is irradiated with ultraviolet light, radiation, or visible light, part of the portion decomposes to release radicals. The action of the radicals causes part of the chemical bonds of a resin to be decomposed, whereby the resin becomes alkali soluble. When the original material for the insulating layer is alkali insoluble, a portion of the material irradiated with light becomes alkali soluble. Subsequently, the resin is washed with an alkaline solution and water, whereby the alkali soluble portion is removed and washed. The so-called patterning formation is performed with the remaining alkali insoluble portion.

Subsequent to the patterning, the insulating layer is preferably subjected to a heat treatment at least twice. To be specific, the following steps are preferably performed after a heating step for removing a solvent residue contained in the patterned insulating layer has been performed.

A second heating step: a step of maintaining a temperature equal to or higher than the heat decomposition temperature of the photosensitive acid-generating portion and lower than the curing or polymerization temperature of the material for the insulating layer.

A third heating step: a step of increasing the temperature of the insulating layer up to a temperature equal to or lower than a temperature obtained by subtracting 20° C. from the decomposition temperature of the material for the insulating layer at a rate of temperature increase of 10° C./min or less and of maintaining the temperature for 30 minutes or longer.

The second heating step is a step of deactivating the photosensitive acid-generating portion of the insulating layer to terminate the progress of the generation of radicals. The third heating step is a step of densifying the film by subjecting the material for the insulating layer patterned in the state of a precursor to, for example, heat polymerization, condensation, condensation polymerization, or the removal of a void volume.

It should be noted that the prior acquisition of characteristic curves for heat absorption and heat generation involved in, for example, the evaporation of the solvent, and the decomposition, polymerization, or fusion of the material or of a component of the material with a differential scanning calorimeter (DSC) suffices for the determination of a temperature condition in each heating step.

When the rate of temperature increase of the insulating layer is excessively high in each heating step, there is a possibility that a temperature distribution in the insulating layer may become uneven and the purpose of the heat treatment may not be achieved. Particularly, in the third heating step, the rate of temperature increase of the insulating layer considerably exceeding 10° C./min results in, for example, an increase in surface roughness of the insulating layer. Therefore, in general, the insulating layer is preferably heated under such a condition that the rate of temperature increase is lower than 10° C./min, though a proper value for the rate of temperature increase depends on a material to be handled.

After the insulating layer has reached a desired temperature in each heating step, the temperature is maintained. When the time period for which the temperature is maintained is insufficient, a reaction scheduled in the heat treatment does not finish, so that the object of the heat treatment may not be achieved. The time period for which the temperature is maintained is not particularly limited because the time period varies depending on the object of each heat treatment, and a numerical condition for the time period in each step also varies depending on a material used. For example, in the third heating step intended for polymerization, the temperature is preferably maintained for 30 minutes or longer. The time period for which the temperature is maintained in accordance with each target reaction can be determined by tracking the extent to which the reaction progresses by, for example, infrared spectroscopy or Raman spectroscopy.

Each heating step is preferably performed in a controlled inert gas atmosphere. For example, when a certain kind of an acrylic resin is formed into a film on a substrate, and the so-called “curing” step is performed under the air, the color of the film changes to thin brown, and the gas barrier property of the film deteriorates, but when the film is cured under the reflux of air filled with dry nitrogen, a thin film having desired characteristics can be obtained.

When the deactivation of the photosensitive acid-generating portion by heating in the second heating step is insufficient, a step of irradiating the insulating layer with light having energy stronger than that of the light with which the insulating layer is irradiated in the patterning is preferably performed. For example, when ultraviolet light having energy about twice or more as high as that of ultraviolet light used in the patterning is applied to the insulating layer, the deactivation of the photosensitive acid-generating portion easily progresses. When an i-ray stepper apparatus is used, exposure energy of 200 mJ/cm² can be used in the patterning, and the deactivation operation (photobleach) can be performed with light having the same wavelength as that of light at the time of patterning exposure and exposure energy of about 400 mJ/cm².

In the third heating step, the temperature of the lower surface of the substrate is preferably set to be lower than the temperature of the upper surface of the substrate. It is known that, in actuality, a temperature in the lower surface of the substrate in contact with and left at rest on a trestle or the like is somewhat lower than a temperature in the upper surface of the substrate to be directly exposed to a heating airflow or infrared light for heating in an oven or the like. The following procedure is preferably performed: the temperature of the lower surface of the substrate is measured by bringing a thermocouple probe into contact with the lower surface in such a manner that the temperature of the upper surface of the substrate does not overshoot in the foregoing state; and temperature control is performed while a temperature difference between the lower surface of the substrate and the upper surface of the substrate is taken into consideration.

Upon production of an organic EL display by using the substrate of the present invention, heating is preferably performed again in a state immediately before the formation of the organic EL layers so that water incorporated after the completion of the step of forming the insulating layer is removed (dehydrated). The re-heating is preferably performed under reduced pressure or in an inert gas atmosphere.

Hereinafter, the present invention will be described in more detail by way of examples. However, the present invention is not limited to the following examples.

### Example 1

An active matrix type organic EL display shown in FIG. 1 was produced.

An acrylic resin resist A having a decomposition temperature of 240° C. is used in the first insulating layer (planarizing film) 103, and a polyimide precursor resist X having a decomposition temperature of 230° C. is used in the second insulating layer (device isolation film) 107. In addition, all heating operations in this example are each performed under the reflux of N₂. The heat characteristics of both the resists are measured in advance with a DSC (manufactured by Mac Science).

(Formation of the First Insulating Layer 103)

First, the resist A is applied onto the base material 101 in which the TFT 102 and circuit wiring have been already formed so that the resist has a thickness of 2 μm (after heat curing). Because the resist A shows an exothermic peak (the heat decomposition or pyrolysis of a photosensitive acid-generating portion) at 120° C., the solvent of the resist is evaporated by maintaining the temperature of the resist at 100° C. for 5 minutes.

After that, patterning is performed by irradiating the resultant with UV through a mask and removing an exposed portion with an alkaline solution. Subsequently, the temperature of the resultant is kept at 130° C. for 30 minutes so that a radical-generating function remaining in the photosensitive acid-generating portion is disabled.

The polymerization reaction of the resist A hardly progresses even when the temperature of the resist is maintained at 130° C. because the resist has a thermal peak that contributes to the curing of the resist at 200° C. In view of the foregoing, the temperature of the resist is increased to 220° C. exceeding the peak that contributes to the curing at 5° C./min, and the temperature is kept for 60 minutes so that the resist is cured. In this case, the heating apparatus is adjusted so that the temperature of the lower surface of the substrate may be equal to a temperature obtained by subtracting 5° C. from the temperature of the upper surface of the substrate.

As a result, the first insulating layer 103 is formed which is transparent and has an outermost surface on which the irregularities of the base material resulting from the TFT or the like are alleviated.

(Formation of the Lower Electrode 104)

Next, Cr is deposited from the vapor onto the base material on which the first insulating layer 103 has been formed so that it has a thickness of 200 nm. Subsequently, a resist (AZ3100 manufactured by Clariant) is applied. The applied resist is irradiated with UV through a mask and treated with a developing solution, whereby only a portion not irradiated with UV is removed. Subsequently, a Cr portion exposed in a resist opening portion is removed with a Cr etchant, and then the residual resist is peeled with a resist peeling solution, whereby the patterned Cr lower electrode 104 is formed.

(Formation of the Second Insulating Layer 107)

Subsequently, in order that the second insulating layer 107 may be formed, the resist X is applied to have a thickness of 0.5 um (after heat curing). Because the resist X shows an exothermic peak (the heat decomposition or pyrolysis of a photosensitive acid-generating portion) at 100° C., the solvent of the resist is evaporated by maintaining the temperature of the resist at 80° C. for 5 minutes.

After that, patterning is performed by irradiating the resultant with UV through a mask and removing an exposed portion with an alkaline solution. Subsequently, the temperature of the resultant is kept at 120° C. for 30 minutes so that the photosensitive acid-generating portion is deactivated.

The polymerization reaction of the resist X hardly progresses even when the temperature of the resist is maintained at 120° C. because the resist has a thermal peak that contributes to the polymerization reaction of the resist at 200° C. In view of the foregoing, the temperature of the resist is increased to 210° C. exceeding the peak that contributes to the polymerization at 5° C./min, and the temperature is kept for 60 minutes so that the resist is cured. In this case, the heating apparatus is adjusted so that the temperature of the lower surface of the substrate may be equal to a temperature obtained by subtracting 5° C. from the temperature of the upper surface of the substrate.

As a result, the second insulating layer 107 is formed which is transparent and is formed into a shape desired for a device isolation film.

Next, the substrate is once exposed to an atmospheric environment at room temperature, and, further, is left at rest at 200° C. under a pressure reduced to 0.1 atmospheric pressure or less for 120 minutes so as to be dehydrated. After that, the substrate is slowly cooled to room temperature again.

(Mass Spectrometry of Substrate)

Subsequently, the substrate was subjected to mass spectrometry while being re-heated in a vacuum TDS apparatus (manufactured by ESCO, Ltd.) at a degree of vacuum of 1×10⁻⁵ Pa. As a result, a decomposition product derived from the first insulating layer 103 at m/z>50 by re-heating up to 220° C. was detected at an S/N ratio smaller than 3/1.

(Formation of the Organic EL Layers 105)

Next, the substrate is introduced into a vacuum deposition apparatus. First, a first mask having an opening only at a position corresponding to a certain pixel of the second insulating layer 107 is placed, and α-NPD is deposited from the vapor to have a thickness of 40 nm, whereby a hole transport layer is formed. Subsequently, Alq3 to which perylene has been added as a guest is deposited from the vapor to have a thickness of 30 nm, whereby a blue-light-emitting layer having a thickness of 20 nm is formed.

Next, a second mask having an opening only at a position corresponding to another certain pixel of the second insulating layer 107 is placed, and α-NPD is deposited from the vapor to have a thickness of 40 nm, whereby a hole transport layer is formed. Subsequently, Alq3 to which a coumarin derivative has been added as a guest is deposited from the vapor, whereby a green-light-emitting layer having a thickness of 20 nm is formed.

Next, a third mask having an opening only at a position corresponding to another certain pixel of the second insulating layer 107 is placed, and α-NPD is deposited from the vapor to have a thickness of 40 nm, whereby a hole transport layer is formed. Subsequently, CBP to which Btplr(acac) has been added as a guest is deposited from the vapor, whereby a red-light-emitting layer having a thickness of 35 nm is formed.

Next, the third mask is removed, and BCP is deposited from the vapor, whereby an electron transport layer having a thickness of 50 nm is formed. Further, LiF is deposited from the vapor, whereby an electron injection layer having a thickness of 1 nm is formed.

(Formation of the Upper Counter Electrode 106)

Further, the substrate on which the organic EL layers have been formed is transferred to a sputtering apparatus while the substrate is prevented from being exposed to external air, and then ITO having a thickness of 200 nm is deposited onto the substrate, whereby the upper counter electrode 106 is formed.

(Formation of the Glass Sealing Member 108)

After that, further, the substrate is transferred to an atmosphere filled with dry N₂, and a unit for shielding water from the outside of the substrate (glass sealing member 108) is connected to the substrate. The glass sealing member 108 is, for example, a member obtained by hollowing out the inside of a glass substrate having a certain thickness and sticking a hygroscopic film containing barium oxide or calcium oxide to the inside. The glass sealing member 108 is bonded and fixed through the adhesive 109 to the outermost surface of the substrate on which layers including up to the upper counter electrode 106 have been formed.

(Evaluation of Organic EL Display for Characteristics)

Here, the substrate is taken out, and external wiring for supplying a driving current or voltage is connected to the substrate. A current or a voltage is applied to cause the portion of the substrate where the organic EL layers are formed to emit light, and the feature of the light emission is evaluated and measured. The organic EL display produced in this example emits uniform light in a pixel surface, and a reduction in emission intensity in the long-term driving of the display and the formation of a perfect non-light-emitting region in a pixel are suppressed as compared to those of an organic EL display produced in Comparative Example to be described later. That is, the degradation of, and a reduction in, the quality of the organic EL display can be suppressed.

### Example 2

An organic EL display was produced in the same manner as in Example 1 except that a polyimide resist Y having a decomposition temperature of 240° C. was used in the first insulating layer (planarizing film) 103 and the first insulating layer 103 was formed as described below.

(Formation of the First Insulating Layer 103)

First, the resist Y is applied onto the base material in which the TFT 102 and circuit wiring have been already formed so that the resist has a thickness of 1 μm (after heat curing). Because the resist Y shows an exothermic peak (the heat decomposition or pyrolysis of a photosensitive acid-generating portion) at 100° C., the solvent of the resist is evaporated by maintaining the temperature of the resist at 90° C. for 5 minutes.

After that, patterning is performed by irradiating the resultant with UV through a mask and removing an exposed portion with an alkaline solution. Subsequently, the temperature of the resultant is kept at 100° C. for 30 minutes so that the photosensitive acid-generating portion is disabled.

The polymerization reaction of the resist Y hardly progresses even when the temperature of the resist is maintained at 90° C. because the resist has a thermal peak that contributes to the polymerization of the resist at 220° C. In view of the foregoing, the temperature of the resist is increased to 230° C. exceeding the peak that contributes to the polymerization at 5° C./min, and the temperature is kept for 60 minutes so that the resist is cured. In this case, the heating apparatus is adjusted so that the temperature of the lower surface of the substrate may be equal to a temperature obtained by subtracting 5° C. from the temperature of the upper surface of the substrate.

As a result, the first insulating layer 103 is formed which is transparent and has an outermost surface with which the irregularities of the base material resulting from the TFT or the like are alleviated.

(Mass Spectrometry of Substrate)

The substrate was re-heated in the same manner as in Example 1. As a result, a decomposition product derived from the first insulating layer 103 at m/z>50 by re-heating up to 220° C. was detected by mass spectrometry at an S/N ratio smaller than 3/1.

(Evaluation of Organic EL Display for Characteristics)

The organic EL display is evaluated in the same manner as in Example 1, whereby results similar to those of Example 1 are obtained.

### Comparative Example

An organic EL display was produced in the same manner as in Example 1 except that, upon formation of each of the first and second insulating layers, after the completion of the patterning, the temperature of each of the first and second insulating layers was increased up to a temperature obtained by adding 10° C. to the curing or polymerization temperature of the material for each of the first and second insulating layers without stopping at a rate of temperature increase of 10° C./min or more, and the temperature was maintained for 60 minutes. It should be noted that, in this case, the steps are advanced while the substrate is placed on a hot plate in an atmospheric atmosphere.

(Mass Spectrometry)

The substrate is re-heated in the same manner as in Example 1. As a result, the release of a mass substance having an m/z in excess of 50 is detected at a re-heating temperature around 170° C. at an S/N ratio of 10/1. The origin of the released product is traced from the mass number of the released product to find that the released product contains a product derived from the resist A used in the first insulating layer. That is, the foregoing means that heating at a temperature equal to or lower than a temperature obtained by subtracting 20° C. from the decomposition temperature of the resist A results in the release of a substance derived from the resist A (probably a decomposition product).

(Evaluation of Organic EL Display for Characteristics)

The organic EL display is evaluated in the same manner as in Example 1. As a result, the non-uniformity of light emission in a pixel interior and a reduction in emission intensity in the long-term driving of the display are observed as compared to the results of Examples 1 and 2, and a perfect non-light-emitting region is formed in a pixel. That is, the degradation of, and a reduction in, the quality of the organic EL display occur remarkably, so that it is hard to adopt the display as a product.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-354679, filed Dec. 28, 2006, which is hereby incorporated by reference herein in its entirety.

What is claimed is:

1. A substrate for an organic EL display comprising an insulating layer, wherein release of a substance derived from a material for the insulating layer by heating at a temperature equal to or lower than a temperature obtained by subtracting 20° C. from a decomposition temperature of the material for the insulating layer is detected by mass spectrometric detection at an S/N ratio smaller than 3/1.

2. A substrate for an organic EL display according to claim 1, wherein the material for the insulating layer is formed of a resin having a photosensitive acid-generating portion.

3. An organic EL display comprising the substrate for an organic EL display according to claim 1.

4. A substrate for an organic EL display comprising:
a planarizing film formed of an organic compound; and
a device isolation film formed of an organic compound,
wherein:
a decomposition temperature of a material for the planarizing film is higher than a decomposition temperature of a material for the device isolation film; and
release of a substance derived from the material for the planarizing film by heating at a temperature equal to or lower than a temperature obtained by subtracting 20° C. from the decomposition temperature of the material for the planarizing film is detected by a mass spectrometric detection method at an S/N ratio smaller than 3/1.

5. A substrate for an organic EL display according to claim 4, wherein the material for the planarizing film and the material for the device isolation film are each formed of a resin having a photosensitive acid-generating portion.

6. An organic EL display comprising the substrate for an organic EL display according to claim 4.

7. A method of producing a substrate for an organic EL display having an insulating layer, the method comprising the step of forming the insulating layer, wherein the step of forming the insulating layer comprises:
a step of applying a solution of a material for the insulating layer having a photosensitive acid-generating portion or a precursor material for the material dissolved or dispersed in a solvent to thereby form a film;
a first heating step of heating the film and removing the solvent in the film;
a step of patterning the film by irradiating the first-heated film with light through a mask;
a second heating step of heating the patterned film under an atmosphere for maintaining a temperature equal to or higher than a heat decomposition temperature of the photosensitive acid-generating portion and lower than a curing temperature or a polymerization temperature of the material for the insulating layer; and
a third heating step of heating the second-heated film under an atmosphere for increasing a temperature of the film up to a temperature equal to or lower than a temperature obtained by subtracting 20° C. from a decomposition temperature of the material for the insulating layer at a rate of temperature increase of 10° C./min or less and maintaining the temperature for 30 minutes or longer.

8. A method of producing a substrate for an organic EL display according to claim 7, wherein the step of forming the insulating layer further comprises a step of irradiating the film with light having energy stronger than that of the light with which the film is irradiated in the patterning after the completion of the third heating step.

9. A method of producing a substrate for an organic EL display according to claim 7, wherein, in the third heating step, a temperature of a lower surface of the substrate is set to be lower than a temperature of an upper surface of the substrate.

10. A method of producing a substrate for an organic EL display according to claim 7, wherein each of the heating steps is performed in an inert gas atmosphere.
